(19) United States
(12) Patent Application Publication
(10) Pub. No.: US 2022/0021286 A1
(43) Pub. Date: Jan. 20, 2022

(54) Electric Potential Energy Generator

(71) Applicant: Brady Thomas, Annapolis, MD (US)

(72) Inventor: Brady Thomas, Annapolis, MD (US)

(21) Appl. No.: 16/932,892

(22) Filed: Jul. 20, 2020

(51) Int. Cl. H02K 19/36; H02K 1/24; H02K 5/10; H02K 7/08; H02K 11/04

(52) U.S. Cl. CPC H02K 19/365; H02K 1/243; H02K 11/046; H02K 7/083; H02K 5/10

(57) ABSTRACT

An electric potential energy (EPE) generator having a throughput shaft and an electrical energy generating rotor assembly. The EPE generator generates electrical energy through the electric potential energy stored within a mechanical system serving a primary mechanical purpose. The mechanical energy has a primary function for the system, while secondarily driving the EPE generator; mechanical energy is not lost in a direct amount to the production of electrical energy. The EPE generator has the capability to generate electrical energy at all states of the system, given that the mechanical rotation is provided; the EPE generator is not limited to operation dependent of mechanical energy transferring either in or out of the system.

### BACKGROUND OF THE INVENTION

This application relates to the generation of electrical energy through electric potential found in mechanical systems, which hold mechanical energy that is applied solely for the gain of electrical energy or is otherwise not utilized for its electric potential. Previously, devices that produce electrical energy, convert mechanical energy to gain the desired electrical energy. In these devices or systems, mechanical energy is lost in direct proportion to that of electrical energy is gained. For example, we consider an alternator on an engine. An alternator is mounted to the engine in a configuration in which the engine can rotate the alternator shaft through mechanical energy. The alternator uses this mechanical rotation to produce electrical energy. The engine loses the mechanical energy that it uses to rotate the alternator shaft to produce the electrical energy. The alternator serves no other mechanical function. This shows the direct relationship of a mechanical system converting mechanical energy to electrical energy. Another example to observe is a windmill. A windmill uses the mechanical energy created from the wind rotating its blades to produce electrical energy. It is comparable to an oversized alternator, but it does not obtain mechanical energy from energy within its own system. The system uses an outside source of energy, the wind, to create this mechanical motion, however all of the mechanical motion harnessed goes directly to producing electrical energy. There is no other purpose served through the mechanical energy seen within the system, and the mechanical energy source serves no other benefit. These prior arts do indeed create electrical energy, which is the desired function of the device. However, they completely spend all of the mechanical energy that goes into creating the electrical energy. These particular devices use rotational mechanical energy, which serves no other function than generating the electrical energy. There also exist system in which mechanical energy is used for mechanical purposes, in which the electric potential of the mechanical devices is not captured. For example, a vehicle is propelled through a system which uses an engine along with multiple rotating shafts and wheels. No electrical energy is gained through the electric potential of the motion of these mechanical devices. This is a loss of electric potential energy that can otherwise be utilized, through implementing electrical energy generator technologies with existing mechanical systems.

### SUMMARY OF THE INVENTION

An electrical energy generation device is designed in which the electric potential in a mechanical system can be used to generate electrical energy, while the system performs another primary, or secondary, mechanical function. This device will serve a mechanical function while also generating electrical energy. The implementation of this device can be seen in the rotational elements of transportation vehicles. The driveshaft of an automobile highlights the functionality of this device. The engine of the vehicle delivers mechanical energy to the driveshaft, which provides rotational mechanical energy to the system to propel the vehicle forward. The rotational mechanical energy of the driveshaft is completely spent on the linear motion of the vehicle. A point on the driveshaft shows to have electrical potential. However, the driveshaft is not configured to harness electrical energy through the mechanical motion that is used. The device can be applied to the driveshaft of the vehicle in a variant of the configuration, depending on the vehicle. This driveshaft will now rotate to propel the vehicle forward, but it will also harness the electrical potential that the driveshaft holds from the mechanical motion and produce electrical energy, while the driveshaft serves its primary function.

### BRIEF DESCRIPTION OF THE DRAWINGS

A specific embodiment has been detailed to depict the advantages of the invention. These embodiments are considered typical and can be modified while still maintaining the benefits of the invention. Therefore, this specific embodiment shall not be considered to limit the scope of the invention.

FIG. 1 is an exploded view of an electric potential energy generator.

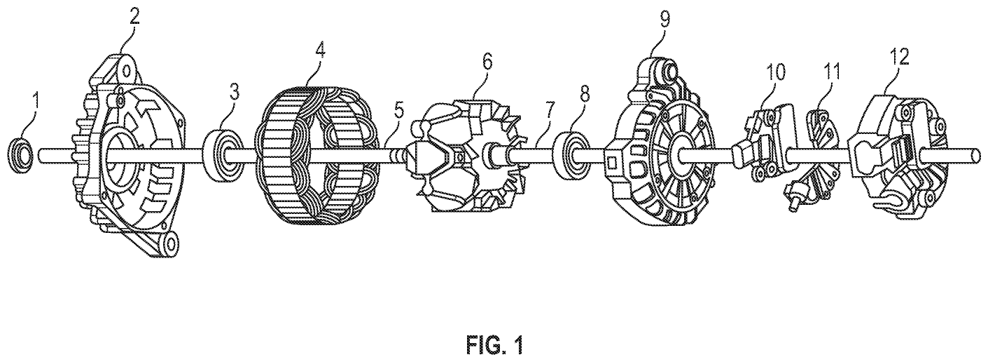

### DETAILED DESCRIPTION OF THE INVENTION

The device is manufactured based on the specific application in which it is to be applied, as it is relevant to all systems in which mechanical energy is utilized. A specific application is that to a rotating shaft. The device is applied to a rotating shaft that is used for rotational mechanical energy, and possibly, in effect, linear mechanical energy. The shaft requires modification to properly interface with the device and thus generate electrical energy through electromagnetic induction. The configuration is similar to that of an alternator, however it is through-shaft driven. The shaft is manufactured such that the input shaft (7) is connected to the output shaft (5), with the rotor (6) fixed at a predetermined point. The rotor (6) utilizes a rotor coil that creates rotating magnetic flux upon rotation. The rotor coil is excited through DC current. The DC current can be sourced through self excitation or externally, dependent on the use of the system. The stator (4) is fixed in a stationary position around the rotor (6). Electromagnetic flux is generated through the amateur coil of the stator (4) as the rotor (6) is rotated. The stator and accompanied amateur coil windings are designed to produce the desired current to benefit the overall system. The input bearing (8) and output bearing (3) are installed in the input casing (9) and output casing (2) respectively. This allows for the input shaft (7), output shaft (5), and rotor (6) assembly to rotate within the device. Input casing (9) and output casing (2) are bonded to encase the rotor (5) and the stator (4). The bonded casing has mounting locations to mount the device and are designed based on the specific system. Seal (1) seals the output casing (2) to protect the internal components. Input cover (12) protects the voltage regulator (10) and rectifier (11), and seals the input casing (9). The voltage regulator (10) regulates the output voltage of the device and is designed to the requirements of the overall system. The rectifier (11) is optional and depends on the requirements of the overall system, but shall be used to convert the AC current produced through the stator (4) armature coils to DC current if required. The specifications and regulations of the assembly are designed such that they serve the electrical needs of the overall system.

1) The electric potential energy generator including;
a throughput shaft, transferring mechanical rotational energy from an output of an element of the system to a mechanical function of the overall system;
a rotor assembly attached to the throughput shaft, generating electrical energy through electromagnetic induction captured by the electric potential energy created by the rotation of the shaft, at all times of rotation;
electrical energy generation capabilities through the electric potential energy of a mechanical system that provides mechanical energy for a primary system function, without limitation to the state of the overall system or mechanical energy transferring either in or out of the system.
